(19) United States
(12) Patent Application Publication
(10) Pub. No.: US 2013/0112562 A1
(43) Pub. Date: May 9, 2013

(54) Real-time observable electrophoresis system which does not require any kind of light filter

(71) Applicant: Tanil Zuhtu Kocagoz, Istanbul (TR)

(72) Inventor: Tanil Zuhtu Kocagoz, Istanbul (TR)

(73) Assignee: SALUBRIS, INC., Woburn, MA (US)

(21) Appl. No.: 13/373,087

(22) Filed: Nov. 4, 2011

(51) Int. Cl. G01N 27/447

(52) U.S. Cl. 204/612

(57) ABSTRACT

This invention avoids the need for UV light as well as all the various filters utilized by prior systems while allowing real-time observation and recording of molecules during electophoresis. This invention is a real-time observable electrophoresis system that avoids the use of light filters as the activation of fluorescent dyes is done by LEDs that give off visible light with a certain wavelength, instead of ultraviolet light, which are positioned not on the top or bottom of the electrophoresis gel but on the sides. The background light that is observed in some gels is eliminated by the image analyzing computer software. This system eliminates the need to filter the wavelength of the activating light and enables the observation and recording of the molecules during the entirety of the electrophoresis.

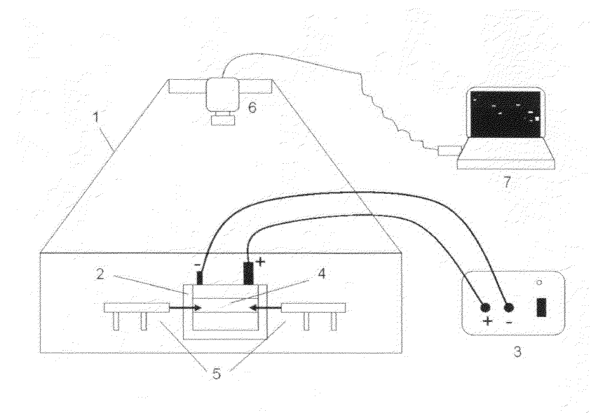

### CROSS REFERENCE TO RELATED APPLICATIONS

Turkish Application for: Real-Time Observable Electrophoresis System Which Does Not Require Any Kind Of Light Filter.

Application No: 2010/02139

Filing Date: Mar. 22, 2010

Relationship of Applications: This is a Turkish application for the same invention to the Turkish Patent Institute.

### STATEMENT REGARDING FEDERALLY SPONSORED RESEARCH OR DEVELOPMENT

Not Applicable

### BACKGROUND OF INVENTION

This invention can be considered within the areas of molecular biology and biochemistry. Electrophoresis is an important research and diagnostic procedure that enables separation and analysis of macromolecules, composing the cells, according to their different features. The electrically charged molecules are separated by applying an electric current to the gel (which is a porous, semi-solid environment) in which the molecules are placed.

In widely used classical electrophoresis systems it is not possible to observe the molecules while they are being separated. In these systems it is possible to see the molecules only after the electrophoretic separation is completed, by staining the molecules with fluorescent dyes and placing the gel in a gel documentation system where the molecules are visualized and photographed. For example in the classical systems, DNA molecules are stained with ethidium bromide and similar molecules, after the electrophoresis is completed which is then activated with UV light making it possible for the DNA molecules to be viewed. It is also possible to observe proteins under UV light using fluorescent dyes that attach to proteins.

Many systems have been defined for viewing the molecules being separated during the electrophoresis process (The numbers for the related patent applications are the following: CN101308116; JP4069548; KR20030082209; U.S. Pat. No. 4,874,492; U.S. Pat. No. 5,449,446; WO2006109902A). All of these systems have proposed the usage of ultraviolet (UV) light in order to activate the fluorescent dyes. However, UV light leads to the formation of thymine dimers in the DNA causing undesired effects in these molecules. Use of electrophoresis involving UV light may prohibit possible subsequent use of the separated DNA moleceles due to the hazard of UV light. Also, UV light causes photo-bleaching, a phenomenon where the dyes attached to the molecules, are either destroyed or broken away from the point they are attached onto the molecule. This is the reason why molecules that are fluorescently bright immediately after they are first stained, in time lose their fluorescence and become more and more dim until they can no longer be viewed. One other disadvantageous aspect of UV light is the necessity to use protective filters. Damaging effects of UV light to eyes and skin require the use of protective filters while observing DNA molecules. Although the UV light is not visible by human eyes, the cameras or sensors which are used for observation are sensitive to UV light and also require filters.

In order to avoid the negative effects of UV light, fluorescent dyes that are activated in visible light and electrophoresis systems that use these dyes for observations have been developed (related patent applications: U.S. Pat. No. 6,198,107; US2005103633A1). In these systems, in order to produce the light at a certain wavelength needed to activate the fluorescent dye, a source of white light is passed through a filter that allows only the required activating wavelength of light to pass. This source of white light is placed underneath the gel in these systems. The camera or the sensor is directly exposed to this activating light which should not be viewed, and this light creates a high background making it difficult for the molecules to be observed. In order to prevent this background light another filter is needed which blocks the light of activating wavelength and allows only the wavelength of light emitted by the flourescent molecules to pass.

This invention avoids the need for UV light as well as all the various filters utilized by prior systems while allowing real-time observation and recording of molecules during electophoresis.

### BRIEF SUMMARY OF THE INVENTION

This invention is a real-time observable electrophoresis system that does not require the use of light filters as the activation of fluorescent dyes is done by LEDs that give off visible light with a certain wavelength, instead of ultraviolet light, which are positioned not on the top or bottom of the electrophoresis gel but on the sides. The background light that is observed in some gels is eliminated by the image analyzing computer software. This system eliminates the need to filter the wavelength of the activating light and enables the observation and recording of the molecules during the entirety of the electrophoresis.

### BRIEF DESCRIPTION OF THE SEVERAL VIEWS OF THE DRAWING

See FIGURE below following the Claims. The description which follows refers to the FIGURE and it's numbered parts. The system is comprised of a box that prevents the entry of light (1) an electrophoresis tank placed in this box (2), a DC power supply (3) powering the electrophoresis, electrophoresis gel (4) placed inside the tank, LEDs (5) that illuminate the gel from the sides, and a camera (6) placed on top of the gel for imaging of the separating molecules hooked into a computer (7) that analyses the images.

### DETAILED DESCRIPTION OF THE INVENTION

This invention enables the observation of molecules separated by electrophoresis, without the need of a light filter.

It enables instant (real-time) visualization of molecules during electrophoresis by combining electrophoresis and gel documentation. It enables visualization, taking photographs and recording the molecules during the whole electrophoresis process without the need for any kind of light filters.

The system designed to meet the purpose of the described invention is shown in the FIGURE. The parts in the FIGURE have been numbered and their descriptions are as follows:
1) Box preventing the entry of light
2) Electrophoresis tank
3) DC (direct current) power supply
4) Electrophoresis gel
5) LEDs, light source that produce single wavelengths of light other than UV.

The system is comprised of a box that prevents the entry of light (1) an electrophoresis tank placed in this box (2), a DC power supply (3) powering the electrophoresis, electrophoresis gel (4) placed inside the tank, LEDs (5) that illuminate the gel from the sides, and a camera (6) placed on top of the gel for imaging of the separating molecules hooked into a computer (7) that analyses the images.

In this system, the molecules stained with fluorescent dyes are illuminated during separation by light sources placed on the side of the gel. For activation of the fluorescent dyes, LEDs (5) with the desired wavelength are used. Since LEDs (5) emit only a single wavelength of light it is not necessary to use a filter to prevent unwanted wavelengths, like in the other previous systems which used white light. Since this LED source does not produce UV wavelengths, the DNA and fluorescent dyes used do not get damaged unlike other systems that use UV light sources. The light that enters the gel (4) hits the fluorescent dyes that tag the desired molecules for observation, making the molecules fluoresce and become visible. The light emitted by the dye is a different color (with a longer wavelength) compared to the activating light source. To produce good imaging, it is necessary for the background light that shines on the back of the gel to be removed. In classical systems, in order to accomplish this, a filter that prevents the wavelength of the activating light source from passing is placed in front of the imaging device so that the activating light source does not affect the analysis. In the system created by this invention, the need for such a filter is eliminated by two applications. The first is the placement of the dye activating light sources, which are placed on the side of the gel, causes the light to enter the gel with an acute angle. The entry of the light with an acute angle causes the light to reflect almost completely from the surface and to stay in the gel. With this arrangement, when transparent gels are observed from above no background light is observed. For gels that are not completely transparent, reflections from within the gel can lead to background light shining; however this problem is removed by the elimination of wavelengths of light different than those emitted by the fluorescence of the molecules, with the use of the computer program (7) which would only display the light emitted from the separating molecules. In color cameras, just like the human eye, receptors for red, green and blue light are found. Color is determined by the magnitude of the effect on these receptors. In other words, each color has a red, green and blue value. For example, let us assume in the observable electrophoresis device that blue light is used for illumination and that the molecules give out green light. In this case the background light shining will be blue and the molecules being observed will be green. If the blue light coming through the receptors of the camera are ignored by the computer program and only the green is displayed then the background light shining will become invisible and only the bands belonging to the molecules are observed. With this application there would no longer be the need to place a filter for blue light in front of the camera.

1. A system that enables instant real-time observation and recording of the images of molecules being separated by electrophoresis, which does not require any light filters, which is comprised of a box preventing the entry of outside light (1), at least one electrophoresis tank (2), at least one DC electric supply (3) powering the electrophoresis tank, light sources (5) placed on the side of the electrophoresis gel (4) that emit only a single wavelength of light other than ultraviolet (UV), a camera (6) taking images from above the gel, and a computer with a software for analyzing the images (7) to which the camera is attached.

2. The activating light source described in claim 1 is comprised of LEDs (5) (light emitting diodes) which produce a single wavelength of light other than UV.

3. The LEDs (5) in claim 2 used in the system described in claim 1 are placed on the side of the electrophoresis gel (4) causing light to enter the gel from the side with an acute angle to the surface of the gel.

4. The image analyzing computer software (7) described in claim 1 is a software that eliminates the background light in the gel by displaying only light of the desired wavelength and eliminating the rest of the light of undesired wavelengths.
